(19) United States
(12) Patent Application Publication
(10) Pub. No.: US 2026/0204610 A1
(43) Pub. Date: Jul. 16, 2026

(54) BATTERY INSPECTION APPARATUS AND BATTERY INSPECTION METHOD

(71) Applicant: SK On Co., Ltd., Seoul (KR)

(72) Inventors: Do Young KIM, Daejeon (KR); Min Gyu LEE, Daejeon (KR)

(21) Appl. No.: 19/450,715

(22) Filed: Jan. 15, 2026

(30) Foreign Application Priority Data
Jan. 16, 2025 (KR) 10-2025-0006622

(51) Int. Cl. H01M 10/04; G01N 21/88

(52) U.S. Cl. CPC H01M 10/04; G01N 21/8851; G01N 2021/8861

(57) ABSTRACT

The present disclosure relates to a battery inspection apparatus and a battery inspection method, including a tray configured to move a battery cell in which a positive electrode, a negative electrode, and a separator separating the positive electrode and the negative electrode are stacked in a first direction, a camera configured to acquire an image of the battery cell, and a control unit configured to determine whether the battery cell is defective based on position data and color data of a terminal portion of the battery cell from the image.

### CROSS-REFERENCE TO RELATED PATENT APPLICATION

The present application claims priority under 35 U.S.C. § 119(a) to Korean patent application number 10-2025-0006622 filed on January 16, 2025, in the Ministry of Intellectual Property, the entire disclosure of which is incorporated by reference herein.

### BACKGROUND OF THE INVENTION

### 1. Field

The present disclosure relates to a battery inspection apparatus and a battery inspection method. More specifically, the present disclosure relates to a battery inspection apparatus and a battery inspection method that improve efficiency of a battery manufacturing process

### 2. Description of the Related Art

Recently, demand for mobile devices such as smartphones, tablet PCs, and wireless earphones has been increasing. In addition, as development of electric vehicles, energy storage batteries, robots, and satellites has been accelerated in earnest, research on high-performance batteries capable of repeated charging and discharging as energy sources has been actively conducted.

When manufacturing batteries, batteries are accommodated in trays, and trays in which the batteries are accommodated are transferred to respective processes and used in manufacturing and inspection processes. However, as transfer methods are

diversified, a case may occur in which batteries are stacked in an opposite direction in the tray. As a result, defects may occur in subsequent processes, and thus, devising a method capable of reducing stacking defects of batteries has been continuously studied.

### SUMMARY OF THE INVENTION

First, according to one aspect of the present disclosure, an object to be solved is to improve efficiency of a battery manufacturing process.

Second, according to another aspect of the present disclosure, an object to be solved is to reduce defects occurring in the battery manufacturing process.

Third, according to still another aspect of the present disclosure, an object to be solved is to check a position and a direction of a battery stacked in a tray.

Fourth, according to another aspect of the present disclosure, an object to be solved is to check stacking defects of a battery stacked in a tray.

Meanwhile, a battery assembly according to the present disclosure may be widely applied in fields of green technology such as electric vehicles (Electric Vehicles), battery charging stations (Battery Charging Stations), energy storage systems (Energy Storage Systems, ESS), and other battery-based applications including photovoltaics (Photovoltaics) and wind power generation (Wind Power). In addition, the battery assembly according to the present disclosure may be used in eco-friendly mobility including electric vehicles and hybrid vehicles for suppressing air pollution and greenhouse gas emissions to prevent climate change.

As a technical means to achieve the technical objects, a battery inspection apparatus according to the present disclosure includes a tray configured to move a

battery cell in which a positive electrode, a negative electrode, and a separator separating the positive electrode and the negative electrode are stacked in a first direction, a camera configured to acquire an image of the battery cell, and a control unit configured to determine whether the battery cell is defective based on position data and color data of a terminal portion of the battery cell from the image.

According to one embodiment, the camera may be disposed to be spaced apart from the battery cell along the first direction, and may acquire an image of the battery cell along the first direction within a field of view.

According to one embodiment, the camera may acquire an image of one surface of a body portion of the battery cell and a portion of the terminal portion of the battery cell along the first direction.

According to one embodiment, the control unit may further include a data processing unit configured to generate the position data and the color data for the battery cell from the image, a position identification unit configured to compare the position data with preset target position data to identify the battery cell and the terminal portion of the battery cell, and a reverse polarity determination unit configured to compare the color data with preset target color data to determine a stacking direction of the terminal portion of the battery cell.

According to one embodiment, when a matching rate between the position data of the battery cell and the target position data deviates from a preset reference range, the position identification unit may determine the battery cell to be defective.

According to one embodiment, when a matching rate between the position data of the battery cell and the target position data is included within a preset reference range, the position identification unit may identify the terminal portion with respect to the battery cell.

According to one embodiment, when the color data of the identified terminal portion and the target color data do not match by comparing the color data with the target color data, the reverse polarity determination unit may determine the battery cell to be defective.

According to one embodiment, when the color data of the identified terminal portion and the target color data match by comparing the color data with the target color data, the reverse polarity determination unit may determine the battery cell to be non-defective.

According to one embodiment, when the control unit determines the battery cell to be defective, the control unit may further include a notification unit configured to provide a notification.

According to one embodiment, a plurality of battery cells may be provided, and the plurality of battery cells may be accommodated in the tray.

As a technical means to achieve the technical objects, a battery inspection method according to the present disclosure includes moving a battery cell in which a positive electrode, a negative electrode, and a separator separating the positive electrode and the negative electrode are stacked in a first direction, acquiring an image of the battery cell, and determining whether the battery cell is defective based on position data and color data of a terminal portion of the battery cell from the image.

According to one embodiment, the step of acquiring the image may include disposing a camera to be spaced apart from the battery cell along the first direction, and acquiring an image of the battery cell along the first direction within a field of view.

According to one embodiment, the step of determining whether the battery cell is defective may further include comparing the position data with preset target position data to identify the battery cell and the terminal portion of the battery cell.

According to one embodiment, the step of determining whether the battery cell is defective may further include comparing the color data with preset target color data to determine a stacking direction of the terminal portion of the battery cell.

According to one embodiment, the method may further include providing a notification when the battery cell is determined to be defective.

First, according to one embodiment of the present disclosure, efficiency of a battery manufacturing process can be improved.

Second, according to another embodiment of the present disclosure, defects occurring in the battery manufacturing process can be reduced.

Third, according to still another embodiment of the present disclosure, a position and a direction of a battery stacked in a tray can be checked.

Fourth, according to still another embodiment of the present disclosure, stacking defects of a battery stacked in a tray can be checked.

### BRIEF DESCRIPTION OF THE DRAWINGS

FIG. 1 is a perspective view illustrating one example of a battery inspection apparatus according to the present disclosure.

FIG. 2 is a block diagram illustrating one example of a configuration of the battery inspection apparatus according to the present disclosure.

FIGS. 3 and 4 are flowcharts illustrating one example of a battery inspection method according to the present disclosure.

FIG. 5 is a top view illustrating one example in which a battery according to the present disclosure is accommodated in a tray.

FIG. 6 is a view illustrating one example of an image of the battery inspection apparatus according to the present disclosure.

FIG. 7 is a perspective view illustrating one example of a bidirectional battery cell applied to the battery inspection apparatus according to the present disclosure.

FIG. 8 is a perspective view illustrating one example of a unidirectional battery cell applied to the battery inspection apparatus according to the present disclosure.

FIG. 9 is a view illustrating a cross-section taken along line AA′ of FIG. 8.

### DETAILED DESCRIPTION

Hereinafter, preferred embodiments of the present disclosure will be described in detail with reference to the accompanying drawings. The configuration of the apparatus or the control method to be described below is provided merely to describe embodiments of the present disclosure and is not intended to limit the scope of the present disclosure, and the same reference numerals used throughout the specification denote the same components.

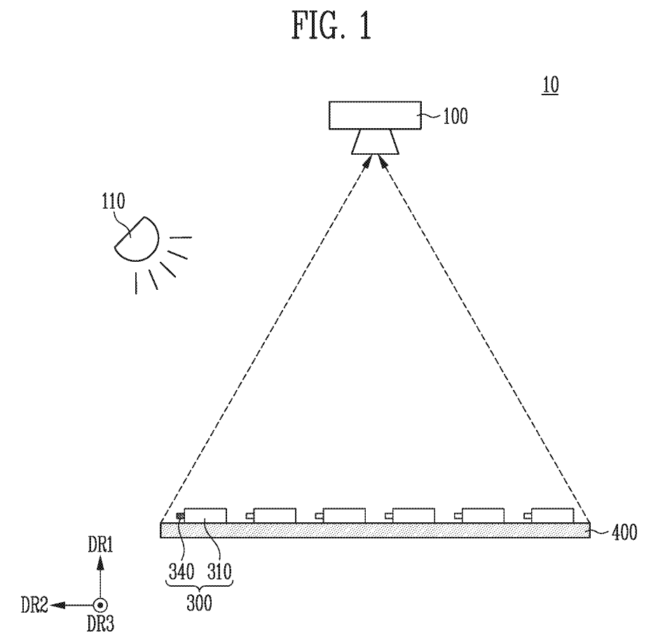

FIG. 1 is a perspective view illustrating one example of a battery inspection apparatus according to the present disclosure.

Referring to FIG. 1, a battery inspection apparatus 10 may include a tray 400 configured to move battery cells 300 and a camera 100 configured to photograph and/or record a video of the battery cells 300.

The battery cells 300 may be provided in plural, and the plurality of battery cells 300 may be accommodated in the tray 400. Depending on a type of transfer method, a case may occur in which the plurality of battery cells 300 is stacked in opposite directions in the tray 400, and stacking defects may thereby occur. For example, in a

battery manufacturing process, when an operator manually transfers the plurality of battery cells 300, the plurality of battery cells 300 may be stacked in opposite directions. When such defects are not quickly recognized and are transferred to a subsequent process, a defect rate may increase and production quality may deteriorate.

Accordingly, through the battery inspection apparatus 10 of the present disclosure, stacking defects of the tray 400 accommodating the plurality of battery cells 300 can be determined during the battery manufacturing process. That is, the battery inspection apparatus 10 can overcome limitations of determining stacking defects of the tray 400 through manual inspection by an operator during the battery manufacturing process.

The battery cells 300 may be secondary batteries capable of being charged and discharged multiple times. For example, the battery cells 300 may be prismatic battery cells in which a body portion 310 is wrapped with a tape. However, embodiments are not limited thereto, and the present disclosure may be applied to all battery cells that do not have feature points on a surface thereof. For example, the battery cells 300 may be pouch-type battery cells.

The camera 100 may acquire an image by recording a video of the battery cell 300. The camera 100 may record a video of an upper surface of the tray 400 including the battery cell 300 to acquire an image including an overall appearance and an arrangement state of the battery cell 300. The camera 100 may acquire an image of one surface of a body portion 310 of the battery cell 300 and a portion of a terminal portion 340 along a first direction DR1.

For example, the camera 100 may acquire, at high resolution, an image including an exact position and shape of the body portion 310 of the battery cell 300,

and an exact position and color of the terminal portion 340. In particular, the camera 100 may acquire an image of a portion of the terminal portion 340 that is displayed in different colors according to polarity. Here, the terminal portion 340 may be displayed in red in the case of a positive electrode and in black in the case of a negative electrode, but is not limited thereto.

The camera 100 may be disposed to be spaced apart from the battery cell 300 along a first direction DR1. The camera 100 may acquire an image of the battery cell 300 along the first direction DR1 within a field of view. Here, the first direction DR1 may be a direction in which a positive electrode, a negative electrode, and a separator separating the positive electrode and the negative electrode are stacked in the battery cell 300. In addition, the first direction DR1 may be a direction perpendicular to a direction in which the tray 400 extends.

The camera 100 may be set to capture an overall appearance and an arrangement state of the battery cells 300 accommodated in the tray 400 within the field of view. The field of view indicates a range that can be captured by the camera 100, and may be appropriately adjusted according to a spaced distance from the first direction DR1. For example, the camera 100 may be disposed at a position set to effectively capture positions and colors of the body portion 310 and the terminal portion 340 of the battery cell 300 within the field of view.

The camera 100 may include a vision camera. For example, the vision camera may acquire a clear image of an inspection target by using a high-resolution image sensor. The vision camera may be provided with various lenses and a focus adjustment function, thereby maintaining an optimal focus according to the inspection target, and may analyze data in real time and execute various algorithms such as pattern recognition, defect detection, and dimensional measurement through image

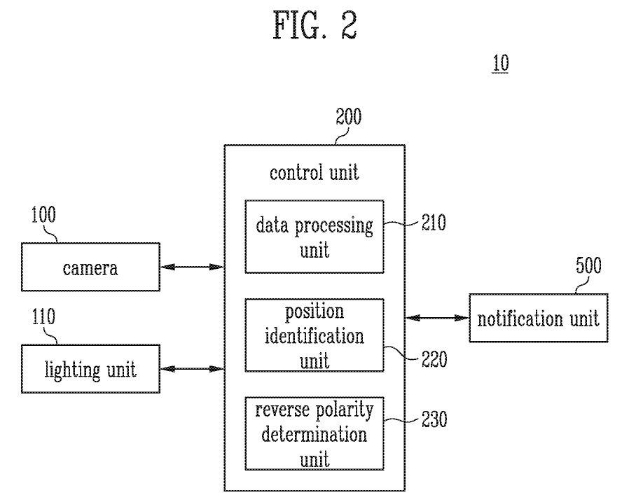

processing software. In addition, the vision camera may exchange data with the control unit 200 (see FIG. 2) or other equipment through a communication interface to inspect physical defects, missing components, or quality of a product. However, embodiments are not limited thereto, and the camera 100 may be modified.

The camera 100 may use a lighting unit 110 while capturing the battery cell 300. The lighting unit 110 may be installed according to a position and an angle of the battery cell 300, and may adjust an optimal illumination angle and brightness during image capturing. Through this, the camera 100 may precisely capture detailed features including a position and a color of the battery cell 300.

The camera 100 may check misalignment of the camera 100 itself by using a mask. For example, by attaching a mask to the tray 400, the camera 100 may check misalignment of the camera 100 itself depending on whether the mask is included within the field of view.

FIG. 2 is a block diagram illustrating one example of a configuration of the battery inspection apparatus according to the present disclosure.

Referring to FIGS. 1 and 2, the battery inspection apparatus 10 may determine whether stacking defects occur in the battery cells 300 accommodated in the tray 400. The battery inspection apparatus 10 may determine whether the battery cells 300 are defective.

The battery inspection apparatus 10 may include a camera 100, a lighting unit 110, a control unit 200, and a notification unit 500.

The control unit 200 may control operations of the camera 100 and the lighting unit 110. The control unit 200 may set a focus, resolution, an image and/or video capturing angle, an image and/or video capturing interval, and an image and/or video capturing timing of the camera 100 to photograph and/or record a video of the battery

cell 300 in real time or at a specific time point. The control unit 200 may adjust illuminance and an angle of the lighting unit 110 so that a body portion 310 and a terminal portion 340 of the battery cell 300 are clearly visible, and may minimize shadows or reflections during photographing and/or video recording.

The control unit 200 may control the camera 100 and the lighting unit 110 to be synchronized with each other. For example, the control unit 200 may allow the camera 100 and the lighting unit 110 to operate simultaneously according to specific photographing and/or video recording conditions to acquire a precise image of the battery cell 300.

The control unit 200 may calculate and process data. The control unit 200 may determine whether the battery cell is defective based on position data and color data of the terminal portion 340 of the battery cell 300 from the image. The control unit 200 may process the image acquired from the camera 100 to determine whether the battery cell 300 is defective. For example, the control unit 200 may include at least one of a DSP Digital Signal Processor, a microprocessor, a CPU Central Processing Unit, a GPU Graphics Processing Unit, an APU Accelerated Processing Unit, an AP Application Processor, an NPU Neural Processing Unit, and a controller.

The control unit 200 may include a data processing unit 210, a position identification unit 220, and a reverse polarity determination unit 230. The data processing unit 210 may generate position data and color data for the battery cell 300 from the image. The position identification unit 220 may compare the position data with preset target position data to identify the battery cell 300 and the terminal portion 340 of the battery cell 300. The reverse polarity determination unit 230 may compare the color data with preset target color data to determine a stacking direction of the terminal portion 340 of the battery cell 300.

The data processing unit 210 may analyze a high-resolution image received from the camera 100 to identify a position of the battery cell 300 in the image and generate position data converted into a coordinate form. For example, the data processing unit 210 may detect an edge or a center point of the battery cell 300 by using image processing algorithms and computer vision technology, and may identify the position of the battery cell 300 based on the detected edge or center point to generate the position data.

In addition, the data processing unit 210 may analyze the high-resolution image received from the camera 100 to extract a color of the battery cell 300 in the image and generate color data converted into a quantitative form. For example, the data processing unit 210 may process the image into a digital format to convert a color of each pixel into RGB (red, green, blue) or another color model (HSL, HSV, etc.). In this case, the data processing unit 210 may identify a boundary of the battery cell 300 in the image, designate a region of interest (ROI) for selecting the terminal portion 340 of the battery cell 300, and identify a color of the terminal portion 340. The data processing unit 210 may extract the color of the terminal portion 340 of the selected battery cell 300 and quantitatively convert the extracted color to generate the color data.

The position identification unit 220 may compare the position data generated by the data processing unit 210 with preset target position data to determine whether the battery cell 300 and the terminal portion 340 are present at specific positions. Here, the target position data may include coordinates or regions preset in advance based on expected positions of the battery cell 300 and the terminal portion 340 arranged in the tray 400.

For example, when a matching rate between the position data of the battery cell 300 and the target position data deviates from a preset reference range, the position identification unit 220 may determine the battery cell 300 to be defective. The position identification unit 220 may calculate exact coordinates of a center of the body portion 310, an edge of the body portion 310, and the terminal portion 340 of the battery cell 300 from the position data. The position identification unit 220 may calculate differences between respective coordinates by comparing the position data with the target position data and may calculate the matching rate. Here, the matching rate is an index indicating how closely the battery cell 300 matches the target position, and may be expressed as a percentage or a difference value. Specifically, when the matching rate is expressed as a percentage, the reference range may be set to 90%, but is not limited thereto. That is, when the position identification unit 220 determines that the matching rate deviates from the preset reference range, the position identification unit 220 may determine that the position of the battery cell 300 is incorrect and may determine the battery cell 300 to be defective.

When the matching rate between the position data of the battery cell 300 and the target position data is included within the preset reference range, the position identification unit 220 may identify the terminal portion 340 with respect to the battery cell 300. When the position identification unit 220 determines that the matching rate is included within the preset reference range, the position identification unit 220 may identify the terminal portion 340 for determining a defect according to a stacking direction of the battery cell 300.

The reverse polarity determination unit 230 may determine whether a stacking direction of the terminal portion 340 of the battery cell 300 is appropriate by comparing the color data generated by the data processing unit 210 with preset target color data.

Here, the target color data may include a color pattern preset in advance based on a color expected when the terminal portion 340 of the battery cell 300 is disposed in a correct stacking direction in the tray 400.

For example, when the color data of the identified terminal portion 340 and the target color data do not match by comparing the color data with the target color data, the reverse polarity determination unit 230 may determine the battery cell 300 to be defective. The reverse polarity determination unit 230 may compare color data extracted from a portion of the terminal portion 340 of the identified battery cell 300 with a color pattern of the target color data. The reverse polarity determination unit 230 may determine whether the terminal portion 340 of the battery cell 300 is disposed in a correct stacking direction in the tray 400 according to whether the color data matches the target color data. When the reverse polarity determination unit 230 determines that the color data does not match the target color data, the reverse polarity determination unit 230 may determine that the terminal portion 340 of the battery cell 300 is disposed in a reverse polarity state. In this case, the reverse polarity determination unit 230 may determine the battery cell 300 to be defective. Here, the terminal portion 340 of the battery cell 300 generally has a specific shape and color, and the reverse polarity state may refer to a state in which the terminal portion 340 of the battery cell 300 is disposed in an incorrect direction.

When the color data of the identified terminal portion 340 and the target color data match by comparing the color data with the target color data, the reverse polarity determination unit 230 may determine the battery cell 300 to be non-defective. When the reverse polarity determination unit 230 determines that the color data matches the target color data, the reverse polarity determination unit 230 may determine that the terminal portion 340 of the battery cell 300 is disposed in a correct direction. In this

case, the reverse polarity determination unit 230 may determine the battery cell 300 to be non-defective.

The notification unit 500 may provide a notification when the battery cell 300 is determined to be defective. When the control unit 200 determines that the battery cell 300 is defective according to an arrangement state of the battery cells 300 accommodated in the tray 400, the notification unit 500 may provide a notification to an operator. The notification unit 500 may turn on a warning light, emit an alarm sound, or display a message on a screen so that the operator may immediately recognize a defective battery cell 300 during the manufacturing process and take an action. However, embodiments are not limited thereto, and the notification may be provided in various manners. In addition, the battery inspection apparatus 10 may stop transfer of the tray 400 to prevent the tray 400 from being transferred to a subsequent process until an arrangement of the defective battery cell 300 is corrected.

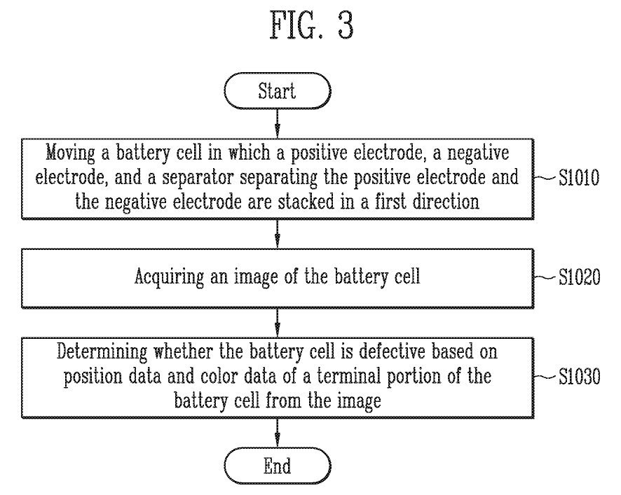

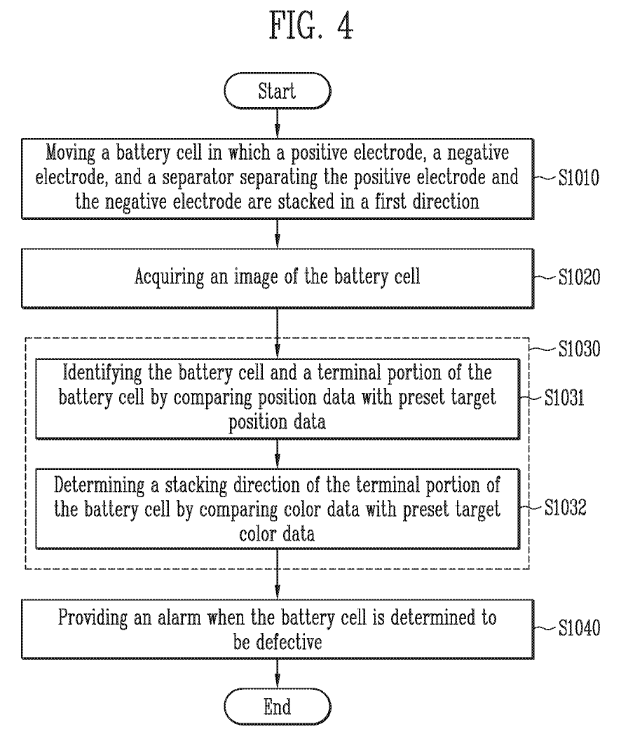

FIGS. 3 and 4 are flowcharts illustrating one example of a battery inspection method according to the present disclosure.

Referring to FIG. 3, the battery inspection method may include a step of moving a battery cell S1010, a step of acquiring an image S1020, and a step of determining whether the battery cell is defective S1030.

In S1010, a battery cell in which a positive electrode, a negative electrode, and a separator separating the positive electrode and the negative electrode are stacked in a first direction may be moved. The battery cell in which the positive electrode, the negative electrode, and the separator are stacked in the first direction may be disposed in a tray. For example, the tray may be configured to be movable, and the battery cell may also be moved by moving the tray. As illustrated in FIG. 1, in the battery inspection apparatus, the tray 400 may be disposed to be spaced apart from

the camera 100 along the first direction DR1 and may be included within a field of view of the camera 100. The tray accommodating the battery cell may be automatically disposed by the battery inspection apparatus or may be manually disposed by an operator.

In S1020, an image may be acquired by photographing and/or video recording the battery cell. In the battery inspection apparatus, the camera may be disposed to be spaced apart from the battery cell along the first direction. The battery inspection apparatus may acquire an image of the battery cell along the first direction in which the positive electrode, the negative electrode, and the separator are stacked, within the field of view, by using the camera. The battery inspection apparatus may acquire an image of one surface of a body portion of the battery cell and a portion of a terminal portion along the first direction by using the camera.

In S1030, whether the battery cell is defective may be determined based on position data and color data of a terminal portion of the battery cell from the image. The battery inspection apparatus may generate position data and color data for the battery cell from the image. For example, the battery inspection apparatus may identify a position of the battery cell in the image received from the camera and generate position data converted into a coordinate form. The battery inspection apparatus may extract a color of the battery cell in the image received from the camera and generate color data converted into a quantitative form.

Referring to FIG. 4, the step of determining whether the battery cell is defective S1030 may further include a step S1031 of identifying the battery cell and a terminal portion of the battery cell by comparing position data with preset target position data. For example, when a matching rate between the position data of the battery cell and the target position data deviates from a preset reference range, the battery inspection

apparatus may determine the battery cell to be defective. In addition, when the matching rate between the position data of the battery cell and the target position data is included within the preset reference range, the battery inspection apparatus may identify the terminal portion with respect to the battery cell.

Referring to FIG. 4, the step of determining whether the battery cell is defective S1030 may further include a step S1032 of determining a stacking direction of the terminal portion of the battery cell by comparing color data with preset target color data. The battery inspection apparatus may determine whether the terminal portion of the battery cell is disposed in a correct stacking direction in the tray according to whether the color data matches the target color data. For example, when the battery inspection apparatus determines that the color data does not match the target color data, the battery inspection apparatus may determine that the terminal portion of the battery cell is disposed in a reverse polarity state and may determine the battery cell to be defective. In addition, when the battery inspection apparatus determines that the color data matches the target color data, the battery inspection apparatus may determine that the terminal portion of the battery cell is disposed in a correct direction and may determine the battery cell to be non-defective.

Referring to FIG. 4, the battery inspection method may further include a step S1040 of providing a notification when the battery cell is determined to be defective. When the battery inspection apparatus determines the battery cell to be defective because the matching rate between the position data of the battery cell and the target position data deviates from the preset reference range, the battery inspection apparatus may provide a notification to an operator. In addition, when the battery inspection apparatus determines the battery cell to be defective because the color data does not match the target color data and the terminal portion of the battery cell

is disposed in a reverse polarity state, the battery inspection apparatus may provide a notification to the operator.

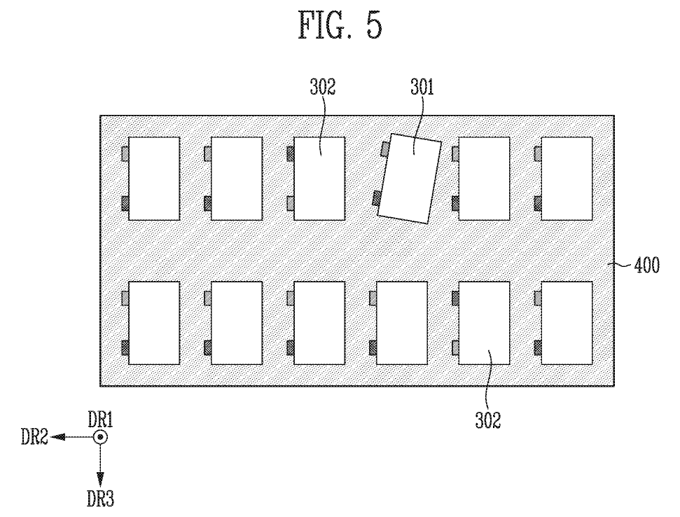

FIG. 5 is a top view illustrating one example in which a battery according to the present disclosure is accommodated in a tray.

Referring to FIG. 5, a plurality of battery cells 300 may be accommodated in the tray 400 at the same time. However, as transfer methods are diversified, at least one battery cell 301 among the plurality of battery cells 300 may be disposed deviating from a preset position of the tray 400. Alternatively, at least one battery cell 302 among the plurality of battery cells 300 may be disposed in a direction opposite to a preset stacking direction.

As such, when improperly disposed defective battery cells are transferred to a subsequent process, a defect rate may increase. Therefore, it may be necessary to quickly recognize defective battery cells among the plurality of battery cells 300 and to reposition the defective battery cells.

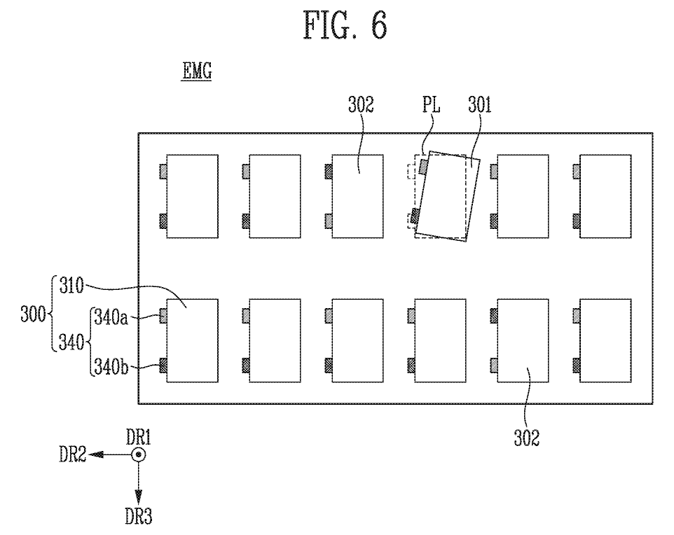

FIG. 6 is a view illustrating one example of an image of the battery inspection apparatus according to the present disclosure.

Referring to FIGS. 1 and 6, the camera 100 of the battery inspection apparatus 10 may photograph and/or record a video of the battery cells 300 to acquire an image EMG. For example, the image EMG may include data indicating positions (or coordinates) and colors (or luminance) of respective battery cells 300.

According to one embodiment, when the plurality of battery cells 300 accommodated in the tray 400 are prismatic battery cells wrapped with a tape, there may be no feature points on a surface thereof other than colors of terminal portions. In this case, the battery inspection apparatus 10 may extract position data of a body portion 310 and a terminal portion 340 of the battery cell 300 and color data of the

terminal portion 340 from the image EMG, and may determine whether the battery cell is defective by using the extracted data.

Referring to FIG. 6, in the image EMG, defectiveness may be determined by comparing position data of the plurality of battery cells 300 with preset target position data PL. Here, the target position data PL may be preset coordinates or regions based on expected positions of the battery cells 300 and the terminal portions 340 disposed in the tray 400.

Actual position data of the plurality of battery cells 300 may be extracted from the image EMG, and how closely the extracted position data matches the target position data may be determined by comparison. For example, when position data of a battery cell 301 has a matching rate of 90% or less compared to the target position data PL, this may indicate that a position of the battery cell 301 significantly differs from or deviates from the target position. That is, the battery cell 301 having a low matching rate may deviate from the target position. Such a battery cell 301 may be determined to be defective because it is determined not to be disposed at a correct position.

In the image EMG, defectiveness may be determined by comparing color data of the plurality of battery cells 300 with preset target color data. Here, the target color data may be a color pattern preset in advance based on colors of the terminal portions 340 expected when the plurality of battery cells 300 is disposed on the tray 400 in a preset stacking direction. For example, among the plurality of battery cells 300, a positive electrode terminal portion 340a may be red and a negative electrode terminal portion 340b may be black. The target color data may be set based on a criterion that, when the plurality of battery cells 300 is disposed in a preset stacking direction, the positive electrode terminal portions 340a and the negative electrode terminal portions

340b of the respective battery cells 300 appear in a specific order. Accordingly, the target color data may be set as a color pattern in which red and black are arranged in order in a third direction DR3 at respective positions according to the preset stacking direction.

When color data of a battery cell 302 is arranged in an order of black and red in a third direction DR3 opposite to the target color data, this may indicate that a stacking direction of the battery cell 302 is opposite to a preset stacking direction. Such a battery cell 302 may be determined to be defective because it is determined not to be disposed in a correct stacking direction.

As such, when an identifiable visual pattern or mark is insufficient on the body portion 310 of the battery cell 300, defective battery cells among the plurality of battery cells 300 can be quickly recognized by using colors of the terminal portions 340, and production quality can be maintained and a defect rate can be reduced by repositioning or removing the defective battery cells before a problem occurs in a subsequent process.

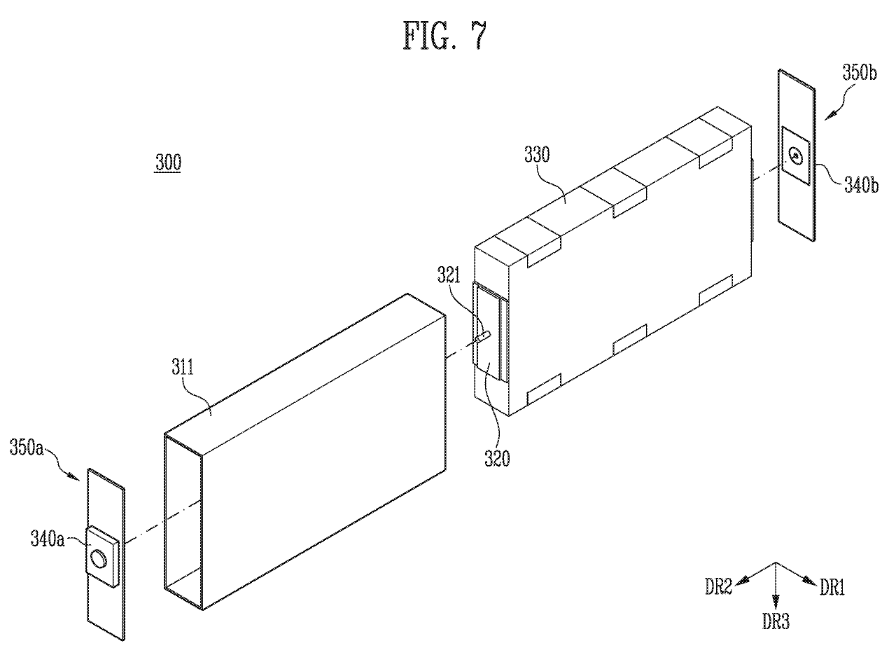

FIG. 7 is a perspective view illustrating one example of a bidirectional battery cell applied to the battery inspection apparatus according to the present disclosure.

Referring to FIG. 7, the battery cell 300 may include an electrode assembly 330 configured to produce or store electrical energy, and a case 311 configured to accommodate the electrode assembly 330 in an accommodating space formed therein. The battery cell 300 may include a first cap assembly 350a coupled to the case 311 to cover one open side of the case 311, and a second cap assembly 350b coupled to the case 311 to cover the other open side of the case 311.

The battery cell 300 may represent a bidirectional battery cell in which a positive electrode terminal portion 340a is formed at one side of the electrode

assembly 330, and a negative electrode terminal portion 340b of the electrode assembly 330 is formed at the other side of the electrode assembly 330.

The case 311 may form an outer shape of the battery cell 300. The case 311 may have a hexahedral shape with both sides open. FIG. 7 illustrates one example of a prismatic battery in which the case 311 has a prismatic shape, but the shape of the battery cell 300 is not limited thereto. For example, the battery cell 300 may be formed as a pouch-type battery cell, a cylindrical battery cell, or another type of battery cell. The case 311 may include a conductive metal such as aluminum, an aluminum alloy, or nickel-plated steel.

The electrode assembly 330 may include a current collector 320 disposed at one side of the electrode assembly 330. The current collector 320 may be a plate-shaped member including a conductive metal. The current collector 320 may be electrically connected to the electrode assembly 330.

The current collector 320 may include a connection pin 321 for electrically connecting the electrode assembly 330 and the first cap assembly 350a. The connection pin 321 may be implemented as a separate member assembled to the current collector 320, or may be integrally formed with the current collector 320.

In addition, although not illustrated in FIG. 7, the battery cell 300 may include a current collector including a connection pin for electrically connecting the electrode assembly 330 disposed at the other side of the electrode assembly 330 and the second cap assembly 350b.

The electrode assembly 330 may be accommodated in the accommodating space formed inside the case 311 in a second direction DR2. The first cap assembly 350a may be assembled to the one open side of the case 311 in a direction opposite

to the second direction DR2. The second cap assembly 350b may be assembled to the other open side of the case 311 in the second direction DR2.

The first and second cap assemblies 350a and 350b may protect the electrode assembly 330 accommodated inside the case 311. The first cap assembly 350a may be welded to the one open side of the case 311. The second cap assembly 350b may be welded to the other open side of the case 311.

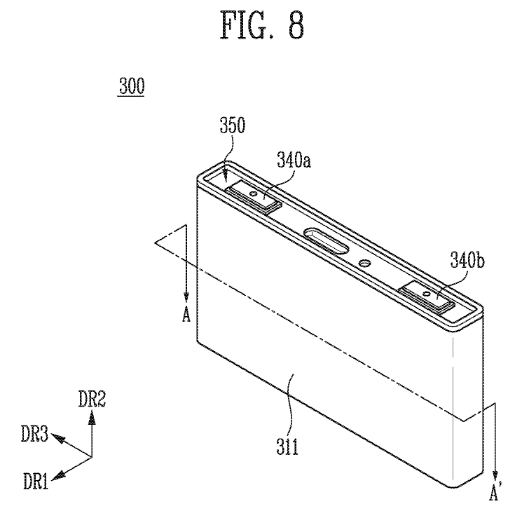

FIG. 8 is a perspective view illustrating one example of a unidirectional battery cell applied to the battery inspection apparatus according to the present disclosure.

Referring to FIG. 8, the battery cell 300 may include an electrode assembly (not shown) configured to produce or store electrical energy, a case 311 configured to accommodate the electrode assembly in an accommodating space formed therein, and a cap assembly 350 coupled to the case 311 to cover one open side of the case 311. The battery cell 300 of FIG. 8 may be configured similarly to the battery cell 300 of FIG. 7. In addition, the cap assembly 350 of FIG. 8 may be configured similarly to the first and second cap assemblies 350a and 350b of FIG. 7. Hereinafter, redundant descriptions will be omitted.

The battery cell 300 may represent a unidirectional battery cell in which a positive electrode terminal portion 340a and a negative electrode terminal portion 340b of the battery cell 300 are formed on one side.

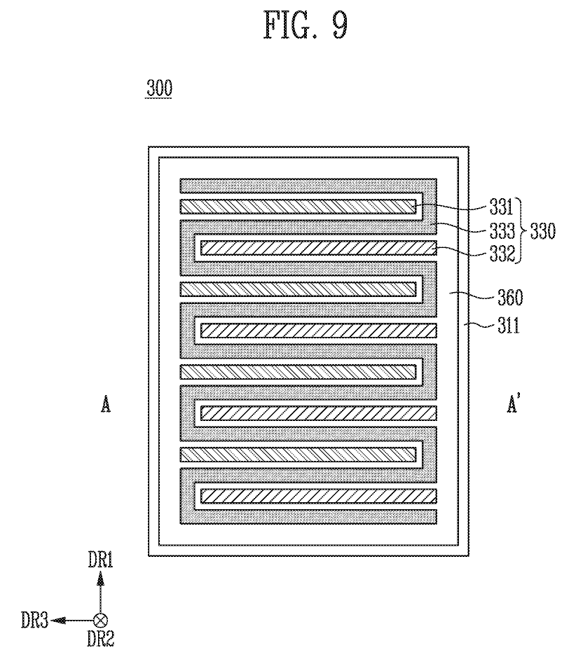

FIG. 9 is a view illustrating a cross-section taken along line AA′ of FIG. 8.

Referring to FIGS. 8 and 9, the electrode assembly 330 of the battery cell 300 may include a positive electrode 331, a negative electrode 332, and a separator 333. In the electrode assembly 330 of the battery cell 300, the positive electrode 331, the negative electrode 332, and the separator 333 separating the positive electrode 331 and the negative electrode 332 may be stacked in a first direction DR1.

The electrode assembly 330 may be referred to as a jelly-roll. The electrode assembly 330 may be manufactured by a winding method in which long sheets of the positive electrode 331, the negative electrode 332, and the separator 333 are wound. Alternatively, the electrode assembly 330 may be manufactured by a folding method (so-called Z-folding method) in which the positive electrode 331 and the negative electrode 332 cut to an appropriate size are inserted between long sheets of the separator 333.

According to one embodiment, in the prismatic battery cell 300, the positive electrode (cathode, 331) of the electrode assembly 330 may refer to a reduction electrode that receives electrons from an electron transfer material when the prismatic battery cell 300 is discharged. The positive electrode 331 may include a positive electrode current collector and a positive electrode active material layer, and the positive electrode active material layer may be formed by a positive electrode slurry composition. In addition, the positive electrode active material layer and the positive electrode slurry composition may include a positive electrode active material. As the positive electrode active material, a known compound may be used. That is, the positive electrode 331 of the electrode assembly 330 may be connected to a positive electrode terminal portion 340a formed at one side of the electrode assembly 330.

In the prismatic battery cell 300, the negative electrode (anode, 332) of the electrode assembly 330 may refer to an oxidation electrode that transfers electrons from an electron transfer material when the prismatic battery cell 300 is discharged. The negative electrode 332 may include a negative electrode current collector and a negative electrode active material layer, and the negative electrode active material layer may be formed by a negative electrode slurry composition. In addition, the negative electrode active material layer and the negative electrode slurry composition

may include a negative electrode active material. As the negative electrode active material, a known compound may be used. That is, the negative electrode 332 of the electrode assembly 330 may be connected to a negative electrode terminal portion 340b formed at the other side of the electrode assembly 330.

In the prismatic battery cell 300, the separator (separator, 333) of the electrode assembly 330 may refer to a membrane that allows passage of an electron transfer material while preventing electrical short-circuit between the positive electrode 331 and the negative electrode 332. The separator 333 may be used without particular limitation as long as it is commonly used in the art. In particular, the separator 333 may be a material having low resistance to ion movement of an electrolyte and excellent electrolyte impregnation capability (wettability).

The prismatic battery cell 300 may include an electrolyte 360 in an internal space of the case 311. The electrolyte 360 may be included in the internal space of the case 311. The electrolyte 360 may refer to a medium that causes movement of an electron transfer material so that an electrochemical reaction between the positive electrode 331 and the negative electrode 332 smoothly occurs. As the electrolyte 360, a commonly used organic liquid electrolyte, inorganic liquid electrolyte, gel-type polymer electrolyte, or molten inorganic electrolyte may be used, but is not limited thereto.

The present disclosure may be implemented in various modified forms, and thus the scope of the present disclosure is not limited to the embodiments described above. Therefore, modified embodiments should be construed as falling within the scope of the present disclosure as long as they include the constituent elements of the claims of the present disclosure.

What is claimed is:

1. A battery inspection apparatus comprising: a tray configured to move a battery cell in which a positive electrode, a negative electrode, and a separator separating the positive electrode and the negative electrode are stacked in a first direction; a camera configured to acquire an image of the battery cell; and a control unit configured to determine whether the battery cell is defective based on position data and color data of a terminal portion of the battery cell obtained from the image.

2. The battery inspection apparatus according to claim 1, wherein the camera is disposed to be spaced apart from the battery cell along the first direction, and acquires an image of the battery cell along the first direction within a field of view.

3. The battery inspection apparatus according to claim 1, wherein the camera acquires an image of one surface of a body portion of the battery cell and a portion of the terminal portion of the battery cell along the first direction.

4. The battery inspection apparatus according to claim 1, wherein the control unit further comprises: a data processing unit configured to generate the position data and the color data for the battery cell from the image; a position identification unit configured to compare the position data with target position data to identify the battery cell and the terminal portion of the battery cell; and a reverse polarity determination unit configured to compare the color data with target color data to determine a stacking direction of the terminal portion of the battery cell.

5. The battery inspection apparatus according to claim 4, wherein the position identification unit determines the battery cell to be defective when a matching rate between the position data of the battery cell and the target position data deviates from a preset reference range.

6. The battery inspection apparatus according to claim 4, wherein the position identification unit identifies the terminal portion with respect to the battery cell when a matching rate between the position data of the battery cell and the target position data is included within a preset reference range.

7. The battery inspection apparatus according to claim 6, wherein the reverse polarity determination unit determines the battery cell to be defective when the color data of the identified terminal portion and the target color data do not match by comparing the color data with the target color data.

8. The battery inspection apparatus according to claim 6, wherein the reverse polarity determination unit determines the battery cell to be non-defective when the color data of the identified terminal portion and the target color data match by comparing the color data with the target color data.

9. The battery inspection apparatus according to claim 1, wherein the control unit further comprises a notification unit configured to provide a notification when the battery cell is determined to be defective.

10. The battery inspection apparatus according to claim 1, wherein a plurality of battery cells is provided, and the plurality of battery cells is accommodated in the tray.

11. A battery inspection method comprising: moving a battery cell in which a positive electrode, a negative electrode, and a separator separating the positive electrode and the negative electrode are stacked in a first direction; acquiring an image of the battery cell; and determining whether the battery cell is defective based on position data and color data of a terminal portion of the battery cell obtained from the image.

12. The battery inspection method according to claim 11, wherein the step of acquiring the image includes disposing a camera to be spaced apart from the battery cell along the first direction, and acquiring an image of the battery cell along the first direction within a field of view.

13. The battery inspection method according to claim 11, wherein the step of determining whether the battery cell is defective further includes comparing the position data with target position data to identify the battery cell and the terminal portion of the battery cell.

14. The battery inspection method according to claim 11, wherein the step of determining whether the battery cell is defective further includes comparing the color data with target color data to determine a stacking direction of the terminal portion of the battery cell.

15. The battery inspection method according to claim 11, further comprising providing a notification when the battery cell is determined to be defective.
